(19) United States
(12) Patent Application Publication
(10) Pub. No.: US 2023/0206419 A1
(43) Pub. Date: Jun. 29, 2023

(54) PERSONALIZED GARMENT FIT COMPARISON AND EVALUATION

(71) Applicant: PIC2SIZE LTD, Tel Aviv (IL)

(72) Inventors: Gil ZUSSMAN, Rishon Lezio (IL); Ilan FEFERBERG, Rishon Lezion (IL)

(73) Assignee: PIC2SIZE LTD, Tel Aviv (IL)

(21) Appl. No.: 17/998,575

(22) PCT Filed: May 13, 2021
(86) PCT No.: PCT/IL2021/050550

§ 371 Date: Nov. 11, 2022

(30) Foreign Application Priority Data
May 14, 2020 (IL) 274673

(51) Int. Cl. G06T 7/00; G06T 19/20; G06T 3/40; A41H 1/00

(52) U.S. Cl. CPC G06T 7/0006; G06T 19/20; G06T 3/40; G06T 7/001; A41H 1/00; G06T 2219/012; G06T 2207/30124; G06T 2219/2016

(57) ABSTRACT

Method and system for facilitating personalized garment fit evaluations over computer network, irrespective of non-uniform garment sizing options. 2D image of a selected garment offered for purchase is received. 2D image of a reference garment having preferred fit for customer and of same garment type as selected garment is received. Selected garment image and reference garment image includes a view of the selected/reference garment flattened against a surface and a measurement reference scale enabling measurement along any two image points. Selected garment and/or reference garment is transformed into a proportional image in which distances between points are presented along a common scale. Selected garment image is compared with reference garment image, and an indication of at least one fit deviation measurement of selected garment relative to reference garment is provided. A fit compatibility of selected garment may be determined and provided based on fit deviation measurement and garment fitting property.

### FIELD OF THE INVENTION

The present invention relates to clothing and garment sizing and measuring, in general, and to the facilitating and customization of garment fit comparison and evaluation for online clothing ordering, in particular.

### BACKGROUND OF THE INVENTION

The gradual but steady growth of electronic commerce (e-commerce) has effectively transformed the shopping experience in recent decades, as online shopping has become commonplace. Various online retail platforms provide a convenient and secure marketplace for consumers and vendors to purchase or sell goods and services over the Internet. A customer or client who wishes to purchase a new product, such as a garment or clothing item, must base his/her purchasing decision on the sizing measurements for the garment provided on the website by the retailer and/or the e-commerce platform. Frequently, incorrect or unsuitable size measurements lead to ill-fitting garments and refund requests for purchases made, causing frustrations and inconvenience to the customer and lost profits by the vendor. Furthermore, an assortment of sizing systems and size measurement standards for clothing are used by different countries and regions. For example, Europe, the U.S., the U.K., Japan, Australia all use different standards for certain garment types, which sometimes involve completely different body measurements and/or clothing dimensions. This tends to cause confusion among the potential consumer, and possibly with the vendor and the garment fabricator as well. Moreover, the same nominal clothing size may vary among different garment fabricators, or even among different brands belonging to the same fabricator. For example, a particular size “XL” (“extra large”) shirt may fit a given customer perfectly, whereas an XL size shirt from a different fabricator or different brand would be tailored differently and the same customer would experience an alternate fit, such as the other XL shirt feeling tighter or looser at certain areas, as compared with the original XL shirt which provides a far more comfortable fit. For example, two XL shirts belonging to different fabricators or brands may be characterized by different sleeve sizes (i.e., one longer than the other) or different shirttail waist circumferences (i.e., one narrower than the other). Even if the size measurements presented on the online retail platform are consistent and are fully comprehended by the potential consumer, he/she may be unfamiliar with or miscalculate his/her own body measurements, and may wind up ordering a garment with an improper fit.

An additional problem is that the size measurements provided on the retail platform sometimes reflects dimensions that are irrelevant to the consumer, while pertinent dimensions are omitted. For example, a consumer may be interested in knowing custom measurements of a selected garment, such as: the front length of a shirt (e.g., from the highest point of the shoulder to the desired hemline), or the neckline opening of a dress, or the sleeve length of a short-sleeved shirt, or the width measurements of a pair of pants along two different sections of the pants leg. Such garment measurements are rarely provided by the retailer, which generally provides only basic standard measurements for a given garment type. Occasionally, a consumer wishes to obtain a certain type of fit for a particular garment type depending on when or where the garment is intended to be worn. For example, she may seek a looser and more comfortable fit for a housedress intended for home wearing, while seeking a tighter fit for a formal dress intended for wearing out in public and special occasions.

Occasionally, a photo or image of the garment (or other product) may be displayed on a retail platform, which includes a visual depiction of certain measurements associated with the product, such as dimensional arrows denoting the width, length and/or height at selected regions. The visual measurement presentation may further include an interface that enables a user to independently calculate a non-indicated dimension of interest in the product image. However, such independent measurements are tedious and time consuming, require precise manual calibrations by the user, are prone to errors, and the user may not even obtain the particular measurements that are actually relevant for determining an optimal fit.

There exist many different techniques for estimating a person's body measurements in order to optimize clothing selection. Such techniques may utilize 3D modeling of the relevant body areas, including via imaging applications that utilize cameras embedded in smartphones or other portable electronic devices. However, these applications tend to not provide a completely accurate model of the body and/or of the garment of interest. For example, the user may have difficulties performing the imaging, or may be unable to obtain an image of sufficient quality, or the application processing may be ineffective. Even if the generated model does manage to provide sufficiently accurate 3D measurements of the body and/or the garment, the conversion from the model measurements into measurements of the actual retail garments may result in errors, either due to faulty conversion from the accurate model to the standard garment sizing measurements, or due to a lack of accurate or correct measurements of the actual retail garment. In particular, 3D model imaging when captured from over a garment will generally result in overly elevated body measurements. On the other hand, many individuals (especially women) are unwilling to obtain images of themselves in an unclothed state or when partially nude, let alone to upload such images to public online retail platforms. Even assuming that the individual is agreeable to undertaking such an imaging process, if the imaging is performed using a (generally inaccurate) smartphone application, and taken over the clothing, then the resultant images would likely be unable to provide an accurate and personalized evaluation of garment fit, for a number of reasons. Firstly, an accurate 3D body model of the (unclothed) customer must be previously acquired and stored and must be accessible by the retail platform, and needs to be compared with a corresponding 3D model of the clothing item that the customer is considering for purchase. However, most online retailers offer countless clothing items for purchase, with a myriad variety of brands and variations of specific garment types. For example, an online retailer may provide hundreds or thousands of different shirt brands, each one offered in different colors or shirt patterns, and each available in a variety of shirt sizes (e.g., S, M, L, XL, XXL, XXXL). Thus, the total number of available shirts increases exponentially with each variation. Since the unit price of an individual shirt is effectively negligible from the retailer standpoint (e.g., a consumer purchase price of a few dollars for a basic T-shirt), it would effectively be uneconomical for the retailer (or vendor or fabricator) to generate and store suitable 3D models for each and every shirt (or other clothing item) in their inventory. In addition, the comparison between a 3D body model and 3D garment model requires substantial processing capacity, memory storage and other computing resources which are generally lacking in typical smartphones or other portable computing devices. Similar problems are encountered when attempting to compare processed digital images Therefore, garment fit recommendations based on comparisons of 3D models have been unsuccessful in practice.

U.S. Pat. No. 10,332,179 to Desmarais et al, entitled: “Methods and systems for recommending fitted clothing”, is directed to the measuring of clothing articles and recommending of clothing products. A portable electronic device camera captures a digital image of a clothing article and a reference object. The reference object is analyzed to determine a scale of the digital image. The clothing article is analyzed using machine vision techniques to determine the clothing type and to recognize type-specific measurement points based on geometry and boundaries of image, and to calculate a determined value for each type-specific measurement based on the determined image scale and determined clothing type. The measurement values are transmitted with a wireless transceiver of the portable electronic device which measures the clothing article. A recommended clothing product is identified from a clothing product database, based on a comparison of the determined measurement values and defined measurements for clothing products contained in the clothing product database.

U.S. Patent Application Publication No. 2007/0100702 to Morley et al, entitled: “Method and system for facilitating ordering of garments”, is directed to the facilitating of garment ordering. A server receives an indication from a user of a desired type of garment. The user may then create a profile for a preferred fitting garment of the desired type, by selecting a garment of the desired type having a preferred fit. The server retrieves a set of key measurements corresponding with the desired garment type, and instructs the user to take measurements of the garment laid flat according to the set of key measurements. The received measurements input by the user becomes the user profile for the garment type and is associated with a user identifier. The user may elect to custom order a garment of the desired type according to the profile, or the server may compare a retail garment of interest with the user profile and provide the user with a display representation of the desired type of garment scaled to an existing set of manufacturer recommendations that most closely match the input set of measurements.

U.S. Patent Application Publication No. 2011/0055054 to Glasson, entitled: “Method for online selection of items and an online shopping system using the same”, is directed to a method for facilitating online selection of an item by a user. The item is selected from a plurality of selection items of different sizes, the selection based on a reference item located remotely from the selection items. The method includes the steps of accessing data relating to a first image of the reference item and a known reference measurement associated with the first image, and accessing data relating to a second image of a selection item and a known reference measurement associated with the second image. The first image data and second image data is processed, based on the respective reference measurements data, to facilitate a visual comparison between at least one dimension of the reference item with at least one corresponding dimension of the selection item. The user is enabled to visually compare the reference item dimension with the corresponding selection item dimension, the result of the comparison enabling the user to select an item from the selection items.

U.S. Patent Application Publication No. 2011/0231278 to Fries, entitled: “Garment sizing system”, is directed to a system and method for identifying a correct garment size for a particular garment type from a plurality of brands. The system may be a client-server system that uses at least one server to host a website, garment sizing software, and at least one database. The consumers access the website over a communication network using networked devices. The database includes garment data such as: garment type, brand name, brand line, retailers that sell the brand, garment size, and dimensional garment measurements. Using the website, the consumer inputs the consumer body measurements or the size of a specific garment known to fit the consumer. The system retrieves from the database the correct size for a specific garment type from a variety of brands based on the inputted data.

U.S. Pat. No. 9,936,754 to Koh, entitled: “Methods of determining measurements for custom clothing manufacture”, is directed to the determination of clothing measurements to allow a custom clothing manufacturer to create an article of clothing with an optimal fit. A raw image of a clothing article and a scale reference is received, and the scale reference is recognized and used to apply a perspective correction to adjust the raw image to produce an adjusted image. A scale of the adjusted image is determined from the scale reference for use with a line measurement tool, causing display of the adjusted image and the line measurement tool on a user display. User input that positions ends of the line measurement tool on measurement reference positions on the adjusted image of the clothing article is received. Multiple clothing article distances between the measurement reference positions on the adjusted image of the clothing article is generated using the line measurement tool. At least three clothing article distances are stored, for use in producing a custom clothing article with a fit based on a favorite clothing article in the raw image.

### SUMMARY OF THE INVENTION

In accordance with one aspect of the present invention, there is thus provided a method for facilitating personalized garment fit evaluations over a computer network, irrespective of non-uniform garment sizing options. The method includes the procedure of receiving at least one 2D image of at least one selected garment offered for purchase, the selected garment image comprising a view of the selected garment flattened against a surface, and a measurement reference scale in relation to the selected garment, enabling measurement along any two points of the 2D image. The method further includes the procedure of receiving at least one 2D image of a reference garment having a preferred fit for a customer and of a same garment type as the selected garment, the reference garment image comprising a view of the reference garment flattened against a surface and a measurement reference scale in relation to the reference garment, enabling measurement along any two points of the 2D image. The method further includes the procedure of transforming, if necessary, at least one of the selected garment image and the reference garment image, into a proportional image in which distances between points are presented along a common scale. The method further includes the procedure of comparing the selected garment image with the reference garment image, and determining and providing an indication of at least one fit deviation measurement of the selected garment relative to the reference garment. The method may further include the procedure of determining and providing an indication of a fit compatibility of the selected garment, based on the fit deviation measurement and based on at least one garment fitting property. The garment fitting property may include: a garment parameter; a body parameter; a property defined by the customer; and/or a property determined by machine learning analysis. The measurement reference scale may include: a reference object with known dimensions; a machine-readable encoding; at least one known distance measurement in the image; another image depicting at least one marked distance measurement; and/or an image captured by an imaging device from a known imaging distance. The 2D selected garment image may be converted into a corresponding 3D selected garment image for display, by generating a 3D projection of the 2D garment onto a generic 3D body model. The method may further include the procedures of displaying a visual representation of the selected garment image and the reference garment image; and providing an indication of at least one measurement between two selected points on at least one of: the reference garment image; and the selected garment image. The fit compatibility may be determined in accordance with differential weightings assigned to at least one of: a plurality of fit deviation measurements; and a plurality of garment fitting properties. At least one of the 2D selected garment image and the 2D reference garment image may include a first image of a principal view of the respective garment, and a second image of a supplemental view of the respective garment. The fit deviation measurement may be expressed as an absolute value or a relative value with respect to at least one body portion of the selected garment. The fit deviation measurement may include: a linear measurement; a non-linear measurement; and/or a planar measurement. The fit deviation measurement may be provided by measuring the distance between two selected points on at least one of: the reference garment image; and the selected garment image. The selected garment image may include a shoe insert image, where the reference garment image includes at least one of: an image of a reference shoe insert; and a drawing of a foot contour.

In accordance with another aspect of the present invention, there is thus provided a system for facilitating personalized garment fit evaluations over a computer network, irrespective of non-uniform garment sizing options. The system includes a garment fit processing module operating on a server computing device coupled to a computer network. The garment fit processing module is configured to receive at least one 2D image of at least one selected garment offered for purchase, the selected garment image comprising a view of the selected garment flattened against a surface, and a measurement reference scale in relation to the selected garment, enabling measurement along any two points of the 2D image. The garment fit processing module is further configured to receive at least one 2D image of a reference garment having a preferred fit for a customer and of a same garment type as the selected garment, the reference garment image comprising a view of the reference garment flattened against a surface and a measurement reference scale in relation to the reference garment, enabling measurement along any two points of the 2D image. The garment fit processing module is further configured to transform, if necessary, at least one of the selected garment image and the reference garment image, into a proportional image in which distances between points are presented along a common scale. The garment fit processing module is further configured to compare the selected garment image with the reference garment image and determine and provide an indication of at least one fit deviation measurement of the selected garment relative to the reference garment. The system further includes a garment fit application executed on a client computing device coupled to a computer network. The garment fit application is configured to receive and display the provided indication. The garment fit processing module may be further configured to determine and provide an indication of a fit compatibility of the selected garment, based on the fit deviation measurement and based on at least one garment fitting property. The garment fitting property may include: a garment parameter; a body parameter; a property defined by the customer; and/or a property determined by machine learning analysis. The garment fit processing module may be further configured to convert the 2D selected garment image into a corresponding 3D selected garment image for display, by generating a 3D projection of the 2D garment onto a generic 3D body model. The garment fit processing module may be further configured to display a visual representation of the selected garment image and the reference garment image, and to provide an indication of at least one measurement between two selected points on at least one of: the reference garment image; and the selected garment image. The fit compatibility may be determined in accordance with differential weightings assigned to at least one of: a plurality of fit deviation measurements; and a plurality of garment fitting properties. At least one of the 2D selected garment image and the 2D reference garment image may include a first image of a principal view of the respective garment, and a second image of a supplemental view of the respective garment. The fit deviation measurement may be expressed as an absolute value or a relative value with respect to at least one body portion of the selected garment. The fit deviation measurement may include: a linear measurement; a non-linear measurement; and/or a planar measurement. The fit deviation measurement may be provided by measuring the distance between two selected points on at least one of: the reference garment image; and the selected garment image. The selected garment image may include a shoe insert image, where the reference garment image includes at least one of: an image of a reference shoe insert; and a drawing of a foot contour.

### BRIEF DESCRIPTION OF THE DRAWINGS

The present invention will be understood and appreciated more fully from the following detailed description taken in conjunction with the drawings in which:

FIG. 1 is a schematic illustration of a network environment supporting a system for facilitating personalized garment fit evaluations over a computer network, constructed and operative in accordance with an embodiment of the present invention;

FIG. 2 is an illustration of an exemplary fit deviation analysis for a first set of garments, operative in accordance with an embodiment of the present invention;

FIG. 3 is an illustration of an exemplary fit deviation analysis for a second set of garments, operative in accordance with an embodiment of the present invention;

FIG. 4 is an illustration of an exemplary fit deviation analysis for a third set of garments, operative in accordance with an embodiment of the present invention;

FIG. 5A is an illustration of an exemplary fit evaluation for a set of shoe inserts, operative in accordance with an embodiment of the present invention;

FIG. 5B is an illustration of an exemplary group of shoe fits, operative in accordance with an embodiment of the present invention; and

FIG. 6 is a block diagram of a method for facilitating personalized garment fit evaluations over a computer network, operative in accordance with an embodiment of the present invention.

### DETAILED DESCRIPTION OF THE EMBODIMENTS

The present invention overcomes the disadvantages of the prior art by providing a method and system for facilitating garment fit evaluations to assist online garment purchasing, by substantially reducing the time and effort required by the consumer, the retailer or vendor, or the fabricator of a selected garment, to instantly provide relevant measurements that can allow for an accurate assessment of the fit of the garment. The disclosed method and system is intended to ensure a customized fit, by providing the consumer with a comparison between a garment being considered for purchase, and a corresponding personal reference garment having a preferred or “ideal” fit for the consumer and representing his/her customized fit characteristics for that garment type. The consumer may obtain an indication of the deviations of the garment considered for purchase respective of the personalized reference garment, without needing to specify specific measurements of the personalized reference garment, without requiring a three-dimensional (3D) mapping or modeling of the respective garments, and without requiring the marking of standard garment sizing measurements. The retailer is able to provide information relating to customized garment proportions quickly and efficiently through online retail platforms, without relying on inaccurate and time-consuming techniques. Correspondingly, the consumer is able to quickly and efficiently obtain the customized garment proportions for evaluating garment fit when purchasing garments online, without needing to dedicate substantial time and effort. The customer may perform a rapid visual assessment by simply glancing at the respective garments, such as by instantly scanning the garment considered for purchase displayed in relation to the personalized reference garment, allowing the customer to quickly assess potential and decide whether to invest further time in evaluating the garment fit. The disclosed method and system is adapted for any type of garment for which a 2D image is capable of conveying garment dimensions or measurements, but may also be applied to other types of products, such as non-garment products characterized by inherent symmetry.

The term “garment”, and grammatical variations thereof, is used herein to broadly refer to any form of clothing or apparel that can be worn by a person on any part of the body. Examples of garments may include, but are not limited to: a shirt; pant; shorts; skirt; dress; hat; coat; jacket; robe; undergarment; sock; stocking; tie; scarf; belt; a fashion accessory; footwear (e.g., shoes, boots, sandals; slippers) and the like. The term “garment type” refers to the general category or sub-category of a given garment. For example, a garment type may be a general “shirt” or may be a more specific type of shirt (e.g., dress shirt; short-sleeved shirt; T-shirt; sweatshirt, blouse; polo shirt; tunic; halter top; tube top; undershirt; and the like).

The term “retailer” as used herein should be broadly interpreted to refer to any individual, group or entity, who is selling or offering for sale a product or service, regardless of whether the purchaser is another retailer (e.g., a wholesaler, a supplier, a vendor, a reseller) or an end user of the product or service.

The term “customer” as used herein should be broadly interpreted to refer to any individual, group or entity, who is purchasing or interested in purchasing a product or service, such as from a retailer, regardless of whether the product or service is intended for use by the customer themselves or by a different entity. The terms “customer” and “consumer” are used interchangeably herein.

The term “measurement” as used herein refers to a linear measurement or distance between two points, such as the distance between two selected points on a garment.

The term “reference object” is used herein to refer to an object having known dimensions which can allow for determination of a 2D coordinate system having an absolute scale.

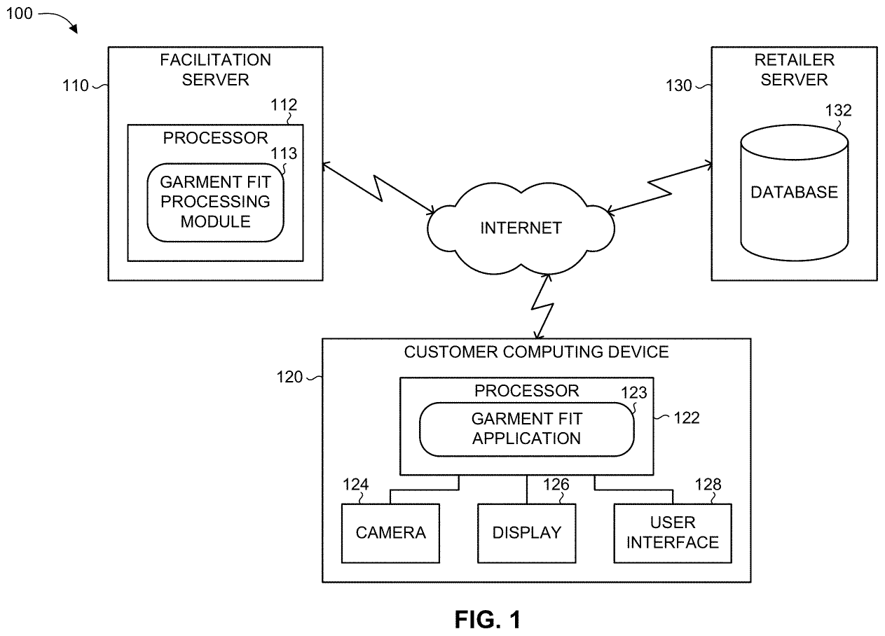

Reference is now made to FIG. 1, which is a schematic illustration of a network environment, generally referenced 100, supporting a computer-implemented system, generally referenced 105, for facilitating personalized garment fit evaluations over a computer network, constructed and operative in accordance with an embodiment of the present invention. Environment 100 includes a facilitation server 110, a customer computing device, and a retailer server 130. Facilitation server 110 includes at least a processor 112. Customer computing device 120 includes at least a processor 122, a camera 124, a display 126, and a user interface 128. Retailer server 130 includes at least a database 132. System 105 includes a garment fit application 123 operating on customer computer processor 122, and a garment fit processing module 113 operating on facilitation server processor 112, although it is appreciated that the functionality of any of the system modules may operate on either or both of server 110 or customer computer 120.

Facilitation server 110, operator computing device 120, and retailer server 130, are communicatively coupled through at least one network, such as the Internet. Accordingly, information may be conveyed between facilitation server 110, customer computing device 120, and retailer server 130, as well as to/from other networks communicatively coupled thereto, over any suitable data communication channel or network, using any type of channel or network model and any data transmission protocol (e.g., wired, wireless, radio, WiFi, Bluetooth, and the like). Customer computer 120 may be remotely located from facilitation server 110 and/or retailer server 130. It is noted that network environment 100 may include a plurality of customer computers operated by multiple respective customers, although a single customer computer 120 is depicted for exemplary purposes. Similarly, network environment 100 may include a plurality of retail servers associated with multiple retailers, but for exemplary purposes only a single retail server 130 is depicted. Customer computing device 120 may be embodied by any type of electronic device with computing and network communication capabilities, including but not limited to: a mobile computer; a desktop computer; a smartphone; a laptop computer; a netbook computer; a tablet computer; or any combination of the above.

Processor 112 of facilitation server 110 generally performs necessary data processing required by server 110, and may receive instructions or information from other components of system 105 or network environment 100, such as from customer computing device 120. Similarly, processor 122 of customer computer 120 performs data processing required by customer computing device 120, and may receive instructions or data from other components of system 105 or network environment 100. For example, garment fit processing module 113 operating on processor 112 of server 110 processes and analyzes information obtained from garment fit application 123 operating on processor 122 of customer computer 120, as will be discussed further hereinbelow.

Customer computing device 120 includes, or is coupled with, a camera 124. Camera 124 may be any type of imaging sensor capable of acquiring and storing an image representation of an object or scene, such as an image of a reference garment of a customer. Accordingly, the term “image” as used herein refers to any form of output from an aforementioned camera, including any optical or digital representation of a scene acquired at any wavelength or spectral region, and encompasses both a single image frame and a sequence of image frames (i.e., a “video image”). Customer computing device 120 further includes, or is coupled with, a display 126 that is configured to present visual content to the customer, such as a display screen. Customer computing device 120 further includes, or is coupled with, a user interface 128 that allows the customer to control parameters or settings associated with computing device 120. User interface 128 may include a cursor and/or a touch-screen menu interface, such as a graphical user interface, configured to enable the customer to manually enter instructions or data. User interface 128 may also include communication devices configured to provide voice communication, such as a microphone and an audio speaker, as well as voice recognition capabilities to enable the user to enter instructions or data by means of speech commands.

Database 132 stores relevant information that can be retrieved and managed by retail server 130, such as details of garments offered for purchase. For example, database 132 may include images of garments, or may include image data allowing for reconstruction of such images.

The components and devices of system 105 may be based in hardware, software, or combinations thereof. It is appreciated that the functionality associated with each of the devices or components of network environment 100 or system 105 may be distributed among multiple devices or components, which may reside at a single location or at multiple locations. For example, the functionality associated with processor 112 or processor 122 may be integrated or may be distributed between multiple processing units. Similarly, at least part of the functionality associated with garment processing module 113 and/or garment fit application 123 may reside externally to facilitation server 110 or customer computer 120. System 105 may optionally include and/or be associated with additional components or modules not shown in FIGS. 1, for enabling the implementation of the disclosed subject matter.

The operation of system 105 will now be described in general terms, followed by specific examples. A customer provides an indication of a garment of interest, such as a retail garment offered for purchase through an online retail platform accessible via garment fit application 123. The term “selected garment” is used herein to refer to a garment of interest selected by the customer. Facilitation server 110 receives the indication of the selected garment, which may include relevant details of the selected garment, such as the garment type, the retailer or retailers selling the garment, and garment measurements, as well as an image of the selected garment. Facilitation server 110 may obtain the garment details and the selected garment image directly from the customer (i.e., via garment fit application 123) or may retrieve or request the garment details or selected garment image from retail server 130 or other online sources.

Facilitation server 110 further requests an image of a garment which is of the same garment type as the selected garment and which has a preferred fit for the intended wearer. The term “reference garment” is used herein to refer to such a garment having a preferred fit and being of the same garment type as the selected garment. For example, the reference garment may reflect a clothing item which ideally fits the customer, or which feels the most comfortable and/or conforms best to his/her body, as compared to all other personal clothing items of that garment type. The customer may provide an image of the reference garment, which may be captured using camera 124, or may be a previously acquired image stored in customer computer 120, or previously uploaded to server 110.

Both the selected garment image and the reference garment image should have certain characteristics. In particular, both images should be captured with the respective garment completely flattened, with substantially no folds or creases or wrinkles, and with all portions of the garment clearly visible. The respective garment should appear in a loose or relaxed state and not be overly stretched. The garment should be laid out flattened on a suitable surface that is flat and large enough to encompass the full garment (e.g., a table, a floor, a wall). The garment may be flattened physically or virtually in the respective image, i.e., if the original image was captured with an angled view of the garment then it may be transformed into a “flattened view” of the garment with suitable image processing modifications. The selected garment image and reference garment image may include a single image with a single perspective view of the respective garment that allows for effective dimensional measurements, such as a front view or a rear view of the garment, or may include a plurality of images taken from multiple perspectives or orientations, e.g., including an orthogonal side view or an angled side view thereof.

In addition, the selected garment image and reference garment image should include at least one “measurement reference scale” which defines a relationship between the actual measurements or sizes of the respective garment and the manner in which these measurements or sizes are portrayed in the respective image. The measurement reference scale may be embedded within the image, or may be provided separately from the image. For example, the measurement reference scale may be a reference object with known geometry and dimensions and which is clearly visible in the field of view of the image. For example, the reference object may be a common item or article having a fixed (unchanging) and known size, shape and measurements, such as a dollar bill, a playing card, or a standard sized sheet of paper (e.g., A4 paper: 210×297 mm). The reference object may also be an item characterized by units of measurement which are clearly marked and denoted, such as a ruler or an extended tape measure. In another example, the reference object may be in the form of a barcode, such as a QR code, or another type of machine-readable optical label embedded in the image, where the size of the barcode can be automatically derived by scanning the barcode in which the size information is encoded, without having to actively mark off multiple reference points on the barcode itself. The reference measurement scale in the image may alternatively be a set of dimensions or units of measurements which are clearly marked in the image itself with respect to the image contents. Further alternatively, at least one measurement or distance between two points within the respective image may be predefined or known, with such predefined measurement provided along with the image. In yet another example, the reference measurement scale may relate to the properties of the camera when capturing the respective image, such as the distance and orientation of the camera lens with respect to the garment (or with respect to the surface on which the garment is positioned) during image capture, such as by the garment fabricator or retailer.

An image captured from a fixed and known imaging distance may be an imaging setup in which the garment is laid flattened on a surface (without folds/creases/wrinkles and with all portions fully visible) and then imaged, following which it may be possible to calculate measurements between two selected points of the garment without requiring a reference object or measurement reference scale embedded in the image. If the image is captured from a non-orthogonal angle (i.e., where the camera is not positioned at approximately 90° relative to the surface), then suitable modifications or corrections may be performed to derive the true measurements.

Facilitation server 110 and/or customer computer 120 may perform pre-processing on the selected garment image and/or the reference garment image, such as to provide a common image scale to be used for determining measurements of the selected garment and the reference garment. For example, server processor 112 may convert one of the images into a transformed image having a common image scale as the other of the images, or correspondingly convert both images into transformed images with a unified image scale, using image processing techniques known in the art. The image transformation may take into account the reference measurement scales of the respective image. Pre-processing may also include manipulating image properties, such as by modifying or removing a background of the reference garment image to conform to the background of the selected garment image (or vice-versa) to allow comparisons to be made. The image transformation or modification is optional, and the original images may alternatively be compared directly without performing pre-processing.

It is noted that a reference selected garment image may include multiple reference/selected garments in a single image, although a single garment depicted in an image is described herein for convenience purposes. Accordingly, analysis of multiple garments in a single image or in multiple images may be performed simultaneously or successively, or analysis may be formed in isolation on a single garment. Similarly, an image may include multiple reference measurement scales, such as to enhance simultaneous measurements of different garments.

To assist the customer in deciding whether to purchase the selected garment, facilitation server 110 compares the reference garment image with the selected garment image to determine an anticipated fit of the selected garment. In particular, the images are analyzed to determine a degree of fit of the selected garment for the intended wearer by using the reference garment as a baseline. The degree of fit may include a fit deviation of the selected garment relative to the reference garment, in at least one portion or region of the garment, and respective of at least one fitting property for the wearer. The deviation of the selected garment from a preferred fit, as represented by the reference garment, may be indicated in terms of the discrepancies between the garments at various garment portions. For example, if the garment is a shirt, then the discrepancies or deviations may be indicated in terms of: the collar, the sleeve, the yoke; the arm hole; the box plate; the cuff; the body upper front; the body lower front; and the bottom hem. Furthermore, different discrepancies may be provided for at least some of these garment portions for both the front of the garment and for the rear of the garment (e.g., front sleeve vs rear sleeve; front hem, vs rear hem; and the like), as well as for each side of the garment where applicable (e.g., left sleeve vs right sleeve). The discrepancies may be calculated and determined in different forms, such as an amount difference (e.g., 1 mm deviation at center of front left cuff) or a percentage or proportional difference (e.g., 98% matching between front hems).

Garment fit application 123 may also allow the customer to obtain selected measurements of the garment, which may not necessarily correspond to standard or conventional garment measurements. In particular, the customer may select a desired linear measurement between two random points on the garment, or a desired planar measurement of a random surface area of the garment. It is noted that a linear measurement may be a straight line between two points, or a curved (non-straight) line between two points, such as along the collar or neckline of a shirt. Garment fit application 123 processes the images to determine the desired measurement, in accordance with the respective measurement reference scales in each image.

The analysis may take into account at least one fitting property, which may be a parameter of the garment or a body parameter of the wearer. Examples of garment parameters may include, but are not limited to: garment material; garment cut; garment shape or profile; garment stretch or flexibility; degree of comfort; garment color; warmth retention of garment; cooling properties or breathability of fabric; and the like. The garment parameters may be reflective of the selected garment and/or the reference garment. The fit deviation analysis may be based on customer-defined criteria, such as a customer indication of one or more parameters of interest for establishing the degree of fit determination. For example, the customer may indicate that the fit deviation at the collar region of the short is of particular significance, while conversely the hem region is of minor significance. Customer input may also include particular garment parameters (e.g., material, cut, fabric composition, breathability) which are considered particularly important or unimportant for the relevant garment analysis. The fitting properties (user-defined or otherwise) may also be differentially weighted in accordance with the respective degree of importance assigned to each. For example, the deviation at the shirt collar may be assigned a relatively high weighting (e.g., a 0.95 factor on a 0-1 scale) whereas the deviation at the bottom hem may be assigned a relatively low rating (e.g., a 0.15 weighting factor). The fit deviation analysis may also be based on automatically defined criteria, such as based on image processing of the respective images, and/or based on machine learning techniques known in the art. For example, fit processing module 113 may be configured to learn the preferences of the customer (or the intended wearer) over time, based on historical data such as previous garment analyses associated with that customer (or intended wearer).

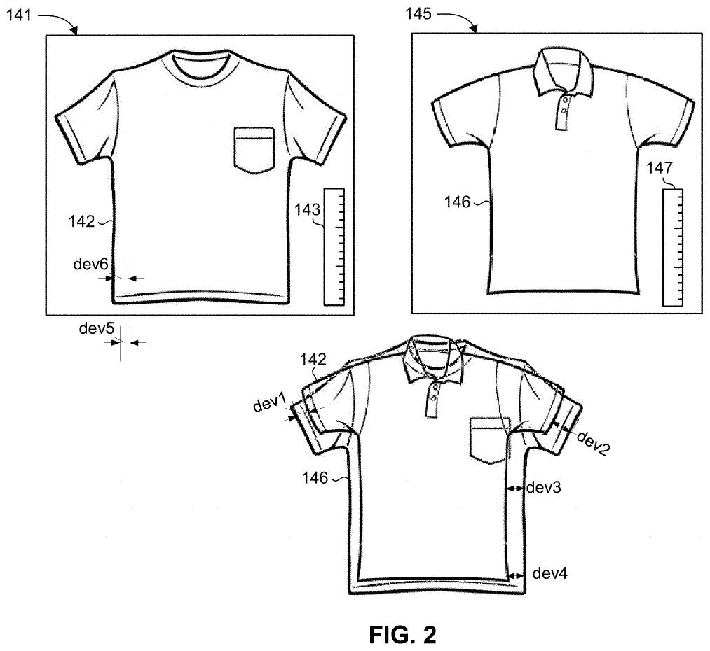

Reference is now made to FIG. 2, which is an illustration of an exemplary fit deviation analysis for a first set of garments, operative in accordance with an embodiment of the present invention. A selected garment image 141 includes a visual representation of a selected shirt, referenced 142, considered for purchase by a customer. Selected garment image 141 further includes a reference object 143 present in the field of view of image 141, for defining an absolute scale for the contents of image 141. A reference garment image, referenced 145, includes a visual representation of a reference shirt, referenced 146, having a preferred fit. Reference garment image 145 further includes a reference object 147 present in the field of view of image 145, for defining an absolute scale for the contents of image 145. A comparison of selected garment image 141 and reference garment image 145 is performed (i.e., by garment fit processing module 113 operating on facilitation server 110) to determine a degree of fit of selected shirt 142, using reference shirt 146 as a baseline. In particular, the discrepancies of selected shirt 142 with respect to reference shirt 146 is calculated at different shirt portions. The calculation utilizes the reference objects 143, 147 to establish a common scale between images 141, 145 and common coordinate system for comparing measurements of shirts 142, 146. In particular, a first deviation (“dev-1”) is determined at the right sleeve, where the right sleeve of reference shirt 146 extends beyond the right sleeve of selected shirt 142 by an amount “dev-1”. Another deviation (“dev-2”) is determined at the left sleeve, in which the left sleeve of reference shirt 146 extends beyond the left sleeve of selected shirt 142 by an amount “dev-2”, which is different than (e.g., larger than) the amount “dev-1” of the right sleeve deviation. Additional deviations are determined at the left side body upper front (“dev-3”) and at the left side body lower front (“dev-4”), by which selected shirt 142 deviates from reference shirt 146 by respective amounts. Finally, deviations are determined at the front bottom hem center (“dev-5”) and at the front bottom hem right edge (“dev-6”), where the front hem right edge deviation “dev-6” is slightly larger than the front hem central deviation “dev-5” for the amount by which selected shirt 142 deviates from reference shirt 146. It is appreciated that the aforementioned deviations are exemplary, and alternative garment portions may be considered instead or in addition to these.

The determined fit deviations are indicated to the customer, such as by garment fit application 123 providing a visual representation of the calculated discrepancies displayed on customer display 126. The customer may visually observe the discrepancies, such as by viewing selected shirt 142 overlaid over reference shirt 146, or vice versa. The discrepancies may be presented using visual markers, such as different colors or shadings applied to the respective garment regions to reflect a particular type of discrepancy or fit deviation characteristic (e.g., “tighter fit” regions shown as red and “looser fit” regions shown as blue. A numerical representation of the discrepancies may also be displayed, such as a percentage or numerical value by which a garment regions reflect a selected fit deviation characteristic. The customer may also perform a cursory visual examination of the garment fit, such as by quickly observing or scanning which garment regions of selected shirt 142 are taut or constricted, and which regions are loose or slack, as compared to reference shirt 146. Such a cursory visual examination can provide an instant assessment that enables the customer to rapidly decide whether it is worthwhile to dedicate additional time and resources in further evaluating the fit properties of the selected shirt 142. Consumers are endlessly exposed to information when online shopping, which tends to be confusing and exhausting. Therefore, the ability to obtain an instant assessment of garment fit potential by merely applying a quick glance or cursory visual scan provides significant convenience and time savings from the consumer standpoint, and also entices further evaluation of selected garments and effectively increases the potential number of customers from the retailer standpoint.

Garment fit application 123 may also provide the customer with a detailed report of the determined fit deviations. The report may include a weighted analysis of the different deviations in accordance with predefined weightings for each garment portion (e.g., user defined and/or determined by automated means), and further accounting for garment parameters. For example, the sleeve deviation may be determined to be of relatively minor importance due to the nature of the selected shirt 142, e.g., due to the type of material providing a high degree of stretching or flexibility at the sleeve portion, as compared with the corresponding material and flexibility of the reference shirt 146, indicating an expected likelihood of fit or comfort for the wearer. Based on the obtained report, the customer can decide whether to proceed with ordering the selected shirt. The report of the fit deviation analysis may also include a recommendation, such as in the form of a percentage of “fit compatibility”, including an overall compatibility level as well as specific compatibility levels at different garment portions (e.g., “the selected shirt matches the reference shirt overall by 82%, including 76% fit compatibility at the sleeves, 88% fit compatibility at the hem; and 84% fit compatibility at the collar). The customer may also compare additional selected garments with the same reference garment, and obtain an indication of the comparative fit compatibility of each of the selected garments considered for purchase.

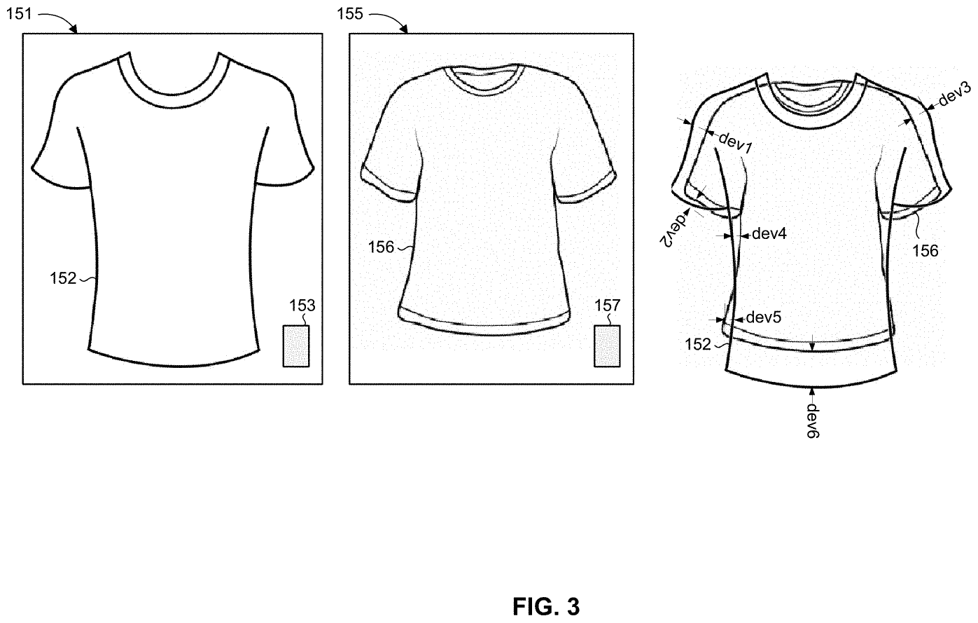

In addition to a visual representation of the reference garment or the selected garment intended for purchase, or an overlay view of one superimposed over the other, garment fit application 123 may also display a virtual ruler (or other measurement object) with associated measurement markings in relation to the displayed garments. The customer may then obtain a visual indication of selected dimensions associated with one or both of the garments by using the reference ruler as a benchmark, such as by applying a cursory visual examination, or by optionally manipulating the displayed position of the virtual ruler in relation to the garments. The customer may also obtain a more precise measurement of selected garment dimensions, such as by selecting two points on the garment via graphical user interface tools (e.g., a mouse cursor) to obtain a linear measurement between the two selected points. Reference is now made to FIG. 3, which is an illustration of an exemplary fit deviation analysis for a second set of garments, operative in accordance with an embodiment of the present invention. A selected garment image 151 includes a visual representation of a selected shirt 152 considered for purchase by a customer, and further includes a reference object 153 for defining an absolute scale in image 152. A reference garment image 155 includes a visual representation of a reference shirt 146 having a preferred fit, and further includes a reference object 157 for defining an absolute scale in image 155. Selected garment image 151 is compared with reference garment image 155 to determine a fit deviation of selected shirt 152 with respect to reference shirt 155. The reference objects 153, 157 are used to establish a common scale between images 151, 155 in the comparison of shirts 152, 156. A first fit deviation (“dev-1”) is determined at the upper portion of the right sleeve, by which selected shirt 152 extends relative to reference shirt 156. It is further determined that selected shirt 152 extends by a second deviation amount (“dev-2”) relative to reference shirt 156 at the right sleeve opening, and by a third deviation amount (“dev-3”) at the upper portion of the left sleeve. At the right side body front shirt region slightly below right sleeve opening, it is determined that selected shirt 152 extends relative to reference shirt 156 by a deviation amount “dev-4”, whereas slightly lower down on the respective shirts it is determined that reference shirt 156 extends relative to selected shirt 152 by another deviation amount “dev-5” at the right side body lower front shirt region. Finally, the central part of the body hem is determined to define a deviation amount “dev-6” by which selected shirt 152 extends relative to reference shirt 156. The customer receives the determined fit deviations, such as in the form of a displayed visual representation of the calculated discrepancies, and an applicable garment fit analysis accounting for relevant garment parameters and other fitting properties, which may be differentially weighted. The garment fit analysis may include a recommendation based on applicable fit compatibility metrics, to facilitate the customer decision regarding the possible purchase of selected shirt 152. The customer may utilize the provided recommendations in formulating a decision, or may employ human intelligence factors, such as intuition or personal experience, in making a selection or modifying a recommendation. For example, the customer may perceive that selected shirt 152 is characterized by a lower hemline (reflected by dev-6) and wider sleeve portions (reflected by dev-1 and dev-2) with respect to the preferred fit of reference shirt 152, but that selected shirt 152 is nevertheless characterized by a near perfect match at the collar portion which may be considered of far greater importance than the hemline or sleeve properties, and therefore may still regard selected shirt 152 as having a “good enough fit” regardless of the other fit deviations.

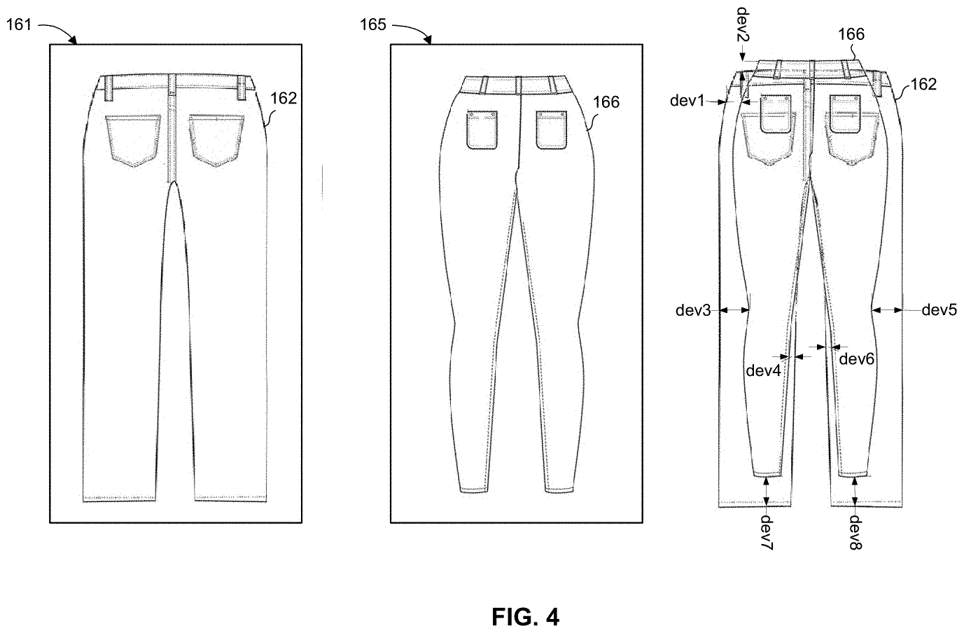

Reference is now made to FIG. 4, which is an illustration of an exemplary fit deviation analysis for a third set of garments, operative in accordance with an embodiment of the present invention. A selected garment image 161 includes a visual representation of a selected pair of pants, referenced 162, considered for purchase by a customer. A reference garment image 165 includes a visual representation of a reference pair of pants 166 having a preferred fit. Selected garment image 161 and reference garment image 165 are each linked to a respective measurement reference scale (not shown) for establishing a common scale between the images 161, 165, such as information regarding the relative distance of the camera when capturing the respective images. Selected garment image 161 is compared with reference garment image 165 to determine a fit deviation of selected pants 162 with respect to reference pants 165. In particular, a first pair of deviations are determined at the left side waistband portion, where the waistband height of reference pants 166 extends by an amount “dev-1” relative to selected pants 162, and the waistband width of selected pants 162 extends by an amount “dev-2” relative to reference pants 166. Another group of deviations are determined at the leg region, where selected pants 162 extends relative to reference pants by an amount “dev-3” at the left side-seam, by an amount “dev-4” at the left inseam, by an amount “dev-5” at the right side-seam, and by an amount “dev-6” at the right inseam. A further set of deviations are determined at the bottom hem region, where selected pants 162 extends relative to reference pants 166 by an amount “dev-7” at the left bottom hem and by an amount “dev-8” at the right bottom hem. The determined fit deviations are indicated to the customer, who may then decide accordingly regarding the possible purchase of selected pants 162.

It is noted that the fit deviation measurements may be linear measurements (i.e., straight line or curved line), or the distance between any two points of the respective garments. For example, a linear measurement may be the distance between the bottom hemline of a pantleg of a selected pair of pants and the bottom hemline of a corresponding pantleg of a reference pair of pants. However, the fit deviation measurements may also be planar or two-dimensional measurements, such as the surface area of a given garment region. For example, a provided fit deviation measurement may be the difference between the surface area of a back pocket of a selected pants relative to the surface area of the corresponding back pocket of a reference pants (e.g., the customer may want the back pocket to have a predefined minimum surface area).

The customer may specify for which garment regions the fit deviation measurements should be provided. For example, referring to selected pants 162 and reference pants 166, the customer may request that deviations be provided for the back pockets, for which fit deviation measurements may not otherwise be provided. The customer may also directly perform desired fit deviation measurements using suitable tools provided by garment fit application 123, such as by applying standard point and click operations on a graphical user interface to select and calculate desired measurements of a selected garment and reference garment. Garment fit application 123 may be configured with default garment portions respective of a given garment type, for which fit deviation measurements should be provided by default. Alternatively, garment fit application 123 may be configured to provide only particular fit deviation measurements specified by the customer, instead of or in addition to default fit deviation measurements. Further alternatively, garment fit application 123 may determine which fit deviation measurements to provide in accordance with relevant fitting properties of the customer or intended wearer, and/or in accordance with historical data, such as previous garment fit analyses or previous garment orders linked to the customer or intended wearer. More generally, such information may also be utilized in performing a garment fit analysis for a given selected garment and for establishing recommendations for a given customer. Garment fit application 123 may utilize machine learning techniques to determine relevant fitting properties and to identify patterns based on historical data. The data analysis may utilize any suitable machine learning approach or algorithm known in the art, including but not limited to: an artificial neural network (ANN) algorithm, such as a recurrent neural network (RNN); a deep learning algorithm; a linear regression, logistic regression or other regression model; and/or a combination thereof. The data analysis may utilize any suitable tool or platform, such as publicly available open-source machine learning or deep learning tools.

It is noted that the fit deviation measurements provided by the present invention may not necessarily reflect standard or “conventional” garment measurements for a given garment type. In general, the fit deviation measurements may reflect any linear measurement between any two random points on a garment, or any planar measurement of any random surface area of the garment. For example, the customer may want to measure the distance between the top edge of the front shirt pocket and the bottom edge of the shirt collar, or the distance between upper edge of the left shirt sleeve opening and the right corner of the bottom hem, neither of which are generally considered conventional shirt measurements and are typically not provided by retailers. It is further noted that the present invention may be applied to any type of garment or item of clothing that could be worn, including fashion accessories and footwear (discussed further hereinbelow), and including “non-conventional” garments, such as new or relatively new clothing items which may be based on new fashion trends.

A retailer may also utilize the method and system of the present invention to display garments for purchase on an online retail platform with customized garment measurements, such as based on user feedback or other relevant parameters, rather than relying on standard or conventional measurements. Typically, online retail platforms display measurements overlaid on an image of the garment, where the measurements are integrated or embedded within the garment image. In accordance with an embodiment of the present invention, the retailer may obtain any random measurement of the garment, and decide which of these measurements to display online to potential customers. The retailer may upload a garment image that includes the customized measurements (i.e., instead of or in addition to default conventional measurements). At a later date, the retailer may decide to modify or remove the existing customized measurements, and determine a different set of customized measurements to be displayed with the garment, in a quick and straightforward manner, as opposed to existing retail platforms in which the measurements integrated with the displayed garment images are fixed and cannot be easily changed. The retail platform may enable the customer to perform searches of available garments filtered according to customized garment measurements and/or other customized fit deviation criteria, to attempt to find an ideal match for the specific customer requirements.

According to an embodiment of the present invention, a selected garment image in 2D is converted into a corresponding 3D image and displayed to the customer. The 3D image of the garment may be generated by expanding the volume of the 2D garment onto a basic or simplified 3D model of a generic body (i.e., rather than using a complex of realistic model of the intended wearer of the garment), using 3D modelling techniques known in the art. A 3D projection of the 2D garment (as reflected in the garment image) can be applied onto the generic 3D body model and used to facilitate garment ordering by a customer. For example, if a customer is considering a particular jacket for purchase, then a three-dimensional model of the selected jacket as worn by a generic body can be displayed to the customer. The 3D model image can be presented from different perspectives or angles, which the customer can select and manipulate the displayed views. For example, the customer can compare a front view of a selected jacket 3D model image and a front view of a corresponding reference jacket 3D model image, and similarly compare the rear views and side views thereof, to assist in the consideration of garment purchase. For example, based on the displayed views the customer may decide to obtain further fit deviation measurements of additional garment portions, or to take into account other fitting properties or garment parameters which were not previously considered.

According to an embodiment of the present invention, the disclosed system and method is used for facilitating the proper fit of a shoe, or general item of footwear, using the removable shoe insert (also known as an “insole” or “inner sole”) of the shoe. In particular, garment fit application 123 may obtain a first image of a selected shoe insert of a shoe considered for purchase by a customer, and a second image of a reference shoe insert of a shoe having a preferred fit for the intended wearer and of the same shoe type as the selected shoe, the images having respective reference measurement scales. Garment fit application 123 compares the two images to determine relevant fit deviation measurements of the selected shoe insert relative to the reference shoe insert. For example, a relevant fit deviation measurement may be the width measurement at the widest portion of the shoe insert (e.g., as measured from the outer (lateral) foot edge to the inner (medial) foot edge). A fit compatibility of the reference shoe can then be determined in accordance with the fit deviation measurements and relevant shoe fitting properties (e.g., type of shoe; shoe material; shape of shoe; orthopedic conditions; and the like) associated with the wearer. It is noted that shoe fitting generally requires a very high degree of precision, where even a miniscule discrepancy in the shoe measurements may drastically influence the fit level of the shoe.

If the customer is unable to remove the shoe insert, the customer may alternatively obtain a reference foot measurement by manually outlining the contours of his/her foot with a drawing tool, using foot contour drawing techniques known in the art. The drawn foot contour image may then serve as a basis for comparison with the selected shoe insert image, in a similar manner as outlined above. The comparison may then utilize relevant properties of the drawn foot contour, such as by examining the relationship between a lateral foot measurement and a transverse foot measurement, with the relationship between the corresponding lateral and transverse measurements of the selected shoe insert.

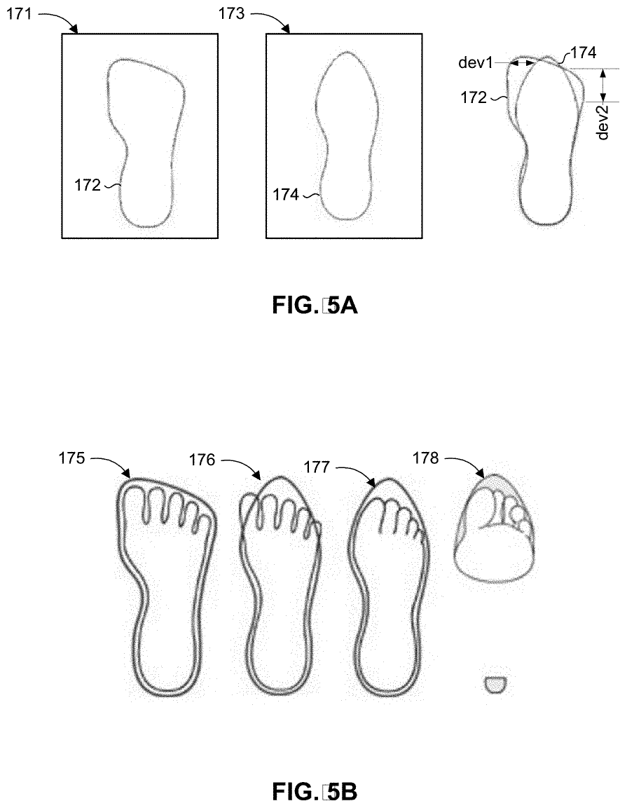

Reference is made to FIG. 5A, which is an illustration of an exemplary fit evaluation for a set of shoe inserts, operative in accordance with an embodiment of the present invention. Shoe insert 171 represent a reference shoe insert having a preferred fit for a customer. Shoe insert 172 represents a selected shoe insert considered for purchase by the customer.

A reference shoe image 171 includes a visual representation of a reference shoe insert 172 belonging to a shoe having a preferred fit for a customer. A selected shoe image 173 includes a visual representation of a selected shoe insert 174 belonging to a shoe considered for purchase by the customer. Reference shoe image 171 and selected shoe image 173 are each linked to a respective measurement reference scale (not shown) for establishing a common scale therebetween. A comparison between reference shoe insert 172 and selected shoe insert 174 can then be made. For example, reference shoe insert 172 and selected shoe insert 174 may be displayed overlaid on one another, such that the customer may visually observe the discrepancies between them. A brief visual examination can provide an indication that the discrepancies are relatively substantial and that the shoe considered for purchase would likely not provide a good customized fit for the customer. In particular, the customer can observe a first fit deviation “dev-1” by which reference shoe insert 172 extends relative to selected shoe insert 174 towards the righthand lateral side at the tip of the upper sole, and a second fit deviation “dev-2” by which reference shoe insert 172 extends relative to selected shoe insert 174 in the longitudinal direction on the left edge of the upper sole. The various discrepancies may be displayed via garment fit application 123 to the customer using visual markers, such as different colors or shadings applied to the different shoe insert regions to reflect a particular type of discrepancy or fit characteristic.

Reference is made to FIG. 5B, which is an illustration of an exemplary group of shoe fits, operative in accordance with an embodiment of the present invention. Image 175 depicts a first shoe shape in which the shoe substantially matches the foot and is therefore a good fit. Image 176 depicts a second shoe shape in which the shoe is too tight for the foot and is therefore an improper fit. Image 177 depicts the second shoe shape in which the shoe substantially matches the foot and is therefore a good fit. Image 178 depicts a third shoe shape (e.g., a high heeled shoe) in which the shoe is too tight for the foot and is therefore an improper fit. Accordingly, an improperly fitting shoe would result in foot deformations and significant discomfort, as well as the potential development of podiatric complications, if the customer were to forcibly wear the improperly fitting shoe despite the improper fit, as is evident from images 176 and 178.

According to an aspect of the present invention, a retailer or garment fabricator may download a computer-implemented application module or add-on configured to be installed on and embedded within an online shopping platform, such that customers who access the online shopping platform are provided with a visual interface associated with the application, represented in FIG. 1 as garment fit application 123 operating on customer computing device 120. The application may be downloaded and installed once, such as pending an approval process and authentication of the retailer or garment fabricator, without requiring subsequent reinstallation. The customer may view a garment image of a garment considered for purchase on the visual interface, and can perform different garment fit evaluation operations quickly and intuitively, such as by applying a single computer input action (e.g., via a single click of a computer mouse or a “one-click” process). For example, following a single mouse click, the customer can choose to perform independent measurements of the garment (e.g., by selecting any two random points on the garment and obtaining an indication of the distance between the selected points), or to compare with a reference garment having a preferred fit. The application may also allow the customer to manipulate the relative positions of the garments, such as by displacing or rotating the potential garment and/or the reference garment to observe the superposition or overlay of the garments in relation to one another (while maintaining the garment properties to allow accurate measurements and comparisons to be made). The application may save measurements or previously performed operations, and present related information to the customer, who may choose to delete or modify selected measurements or perform additional operations as desired. The settings or parameters associated with the garment fit application may be controlled or modified by the retailer or garment fabricator, without requiring direct involvement by the customer. For example, the retailer or garment fabricator may select how the garment images are displayed through the application interface, which default garment measurements are presented, the manner in which hyperlinks and garment details are provided, and other relevant settings.

It will be appreciated that the present invention may facilitate online garment ordering by providing information that is generally not provided or cannot be provided by the retailer, such as fit deviation measurements and analysis adapted to the specific requirements of the customer. More generally, the present invention provides an indication of garment proportions customized to the needs of a particular customer, which he/she may then utilize to facilitate subsequent garment purchases. The system and method of the present invention may provide garment fit analysis and recommendations for garments for which it is difficult or impossible to define relevant size measurements, such as nonconventional garment types or new garments or garments that that have previously not been widely marketed. Accordingly, the present invention may provide nontypical or nonconventional measurements, such as a distance between any two random points or any random surface area, for standard or common garments, as well as nonconventional measurements (as well as conventional measurements) for nonconventional garments. The system and method of the present invention further allows for personalization of the garment ordering process, allow the customer to specify which garment measurements are of particular interest and/or which fitting properties should be taken into account, and can assign different values (or weightings) to different garment measurement and/or fitting properties. For example, the customer can select a customized fit for a given garment based on personalized criteria, such as depending on how or when or where the garment is intended to be worn.

Furthermore, the retailer is able to provide customers with information relating to garment proportions in a simple and straightforward manner, without relying on inaccurate and inefficient smartphone applications or visual interfaces that require a time-consuming manual marking of desired garment measurements. At the same time, the customer is able to quickly and efficiently obtain the relevant garment proportions customized for providing a proper fit, for an extensive assortment of potential garments offered for purchase online, without needing to dedicate significant time, effort or resources. The customer may obtain a rapid assessment of the garment potential fit by applying a simple glance or cursory visual examination before deciding whether to apply a more detailed fit evaluation. The system and method may be seamlessly integrated with existing online retail platforms, such as by allowing garment images depicting customized garment measurements to be generated and uploaded onto the retail platform simply and efficiently. The garment images are displayed in an intuitive visual presentation that enables the customer to quickly and easily assess the garment for potential purchase, such as after simply applying a single computer input action (e.g., a single “mouse click”). The present invention may provide recommendations based on machine learning of large collections of data, such as historical data associated with the relevant customer or wearer and/or historical data of a large group of customers or wearers associated with a relevant garment or garment type. Accordingly, the present invention may remove hassles and inconvenience in the garment purchasing experience, for both customers and retailers, saving valuable time and avoiding refund requests or dissatisfied purchases.

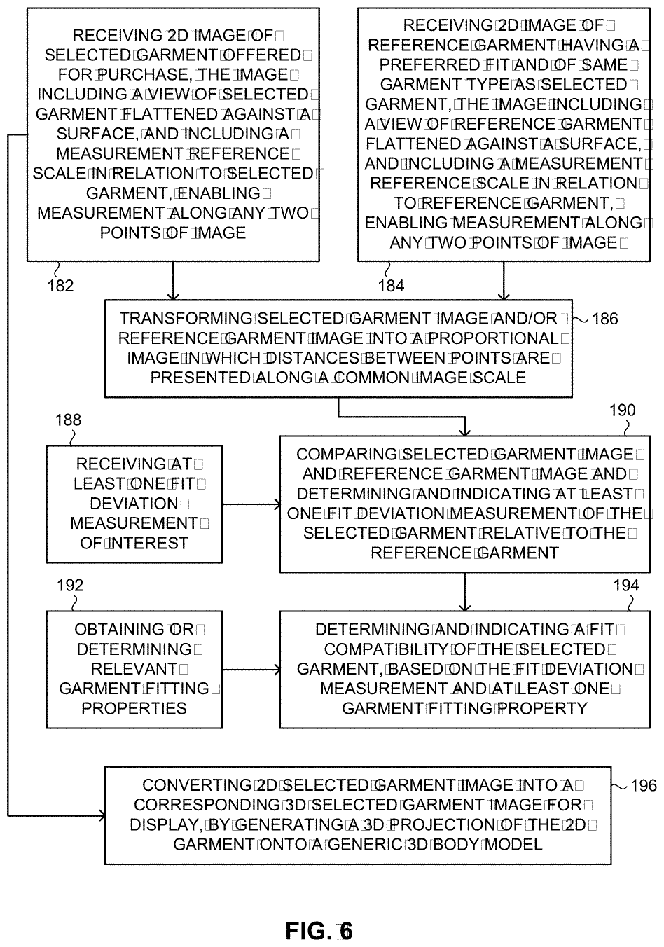

Reference is now made to FIG. 6, which is a block diagram of a method for facilitating personalized garment fit evaluations over a computer network, operative in accordance with an embodiment of the present invention. In procedure 182, a 2D image of a selected garment offered for purchase is received, the image including a view of the selected garment flattened against a surface and including a measurement reference scale in relation to the selected garment, enabling measurement along any two points of the image. Referring to FIGS. 1 and 2, garment fit processing module 113 of facilitation server 110 receives selected garment image 141 depicting selected shirt 142 and depicting reference object 143. The measurement reference scale may alternatively be an indication or depiction of one or more known distance measurements in the image, or information regarding the relative distance of the camera from selected shirt 142 when capturing image 141. Selected shirt 142 appears (physically or virtually) flattened against a suitable surface in image 141 with substantially no creases or folds or wrinkles.

In procedure 184, a 2D image of a reference garment, having a preferred fit and of the same garment type as the selected garment, is received, the image including a view of the selected garment flattened against a surface and including a measurement reference scale in relation to the selected garment, enabling measurement along any two points of the image. Referring to FIGS. 1 and 2, garment fit processing module 113 of facilitation server 110 receives reference garment image 145 depicting selected shirt 146 and depicting reference object 147. The measurement reference scale may alternatively be an indication or depiction of one or more known distance measurements in the image, or information regarding the relative distance of the camera from reference shirt 146 when capturing image 145. Reference shirt 146 appears (physically or virtually) flattened against a suitable surface in image 145 with substantially no creases or folds or wrinkles.

In an optional procedure 216, the selected garment image and/or the reference garment image is transformed into a proportional image in which distances between points are presented along a common image scale. Referring to FIGS. 1 and 2, garment fit processing module 113 of facilitation server 110 may perform pre-processing on selected garment image 141 or reference garment image 145, if necessary to provide a common image scale for determining subsequent garment measurements. For example, garment fit processing module 113 may convert selected garment image 141 into a corresponding image having a common image scale as reference garment image 145, based on the respective reference objects 143, 147, using image processing techniques known in the art. Each of selected garment image 141 and reference garment image 145 may include multiple images reflective of different views of the garment, such as a first image of a principal view of the respective garment (e.g., a front view or a rear view thereof), and a second image of a supplemental view of the respective garment (e.g., a side view thereof). Garment fit processing module 113 may optionally perform other pre-processing, such as to modify or remove a background of reference garment image 145 to conform to the background of selected garment image 141 (or vice-versa) to enable subsequent comparisons.

In an optional procedure 188, at least one fit deviation measurement of interest is received. Referring to FIGS. 1 and 2, garment fit processing module 113 of facilitation server 110 may receive an indication of one or more deviation measurements which the customer is interested in obtaining for selected shirt 142 and reference shirt 146. For example, the customer may wish to obtain a nonconventional measurement, such as the distance between the bottom edge of the shirt collar and the top edge of the front shirt pocket, in relation to selected shirt 142 and reference shirt 146. The customer may provide this information manually (e.g., via user interface 128 of customer computer 120) to be subsequently used for establishing which fit deviation measurements should be determined and indicated by garment fit application 123. The customer may also perform the desired fit deviation measurement directly using garment fit application 123 via suitable application tools adapted for user manipulations. Garment fit application 123 may alternatively be configured to provide default fit deviation measurements respective of default garment portions for a given garment type, instead of or in addition to the customer provided measurement of interest. Further alternatively, garment fit application 123 may determine one or more fit deviation measurements to provide based on properties or historical data linked to the customer or the intended wearer.

In procedure 190, the selected garment image and the reference garment image are compared, and at least one fit deviation measurement of the selected garment relative to the reference garment is determined and indicated. Referring to FIGS. 1 and 2, garment fit processing module 113 of facilitation server 110 compares selected garment image 141 and reference garment image 145, and determines one or more fit deviation measurements of selected shirt 142 relative to reference shirt 146. For example, one deviation measurement is determined at the right sleeve portion, where reference shirt 146 extends beyond selected short 142 by an amount “dev-1”. Another deviation measurement is determined at the front bottom hem center portion, where reference shirt 146 extends beyond selected short 142 by an amount “dev-5”. The determined deviation measurements are then provided via garment fit application 123 of customer computer 120, such as being presented visually on customer display 126. The fit deviation measurements may be expressed as an absolute value (e.g., 1 mm deviation at right sleeve opening) or a relative value (e.g., 5% deviation at shirt hem length). It is appreciated that the comparison and indication of a fit deviation measurement may be performed by the customer (using garment fit application 123), and may also encompass a visual assessment of the garment deviations, such as by simply observing how the selected garment appears in relation to the reference garment, without necessarily obtaining a numerical garment measurement. Determining and indicating at least one fit deviation measurement may also encompass the customer manipulating the views of the garment images, such as by rotating or shifting the view of the selected garment relative to the reference garment (or vice-versa), as well as performing customized garment measurements on the garment images, including non-conventional measurements.

In an optional procedure 192, at least one garment fitting property of relevance is obtained or determined. Referring to FIGS. 1 and 2, garment fit processing module 113 of facilitation server 110 may receive an indication of one or more fitting properties associated with the intended wearer, which should be taken into account in the garment fit analysis for determining fit compatibility. For example, the fitting property may be a garment parameter, such as: garment material; garment cut; garment shape or profile; garment stretch or flexibility; garment color; warmth retention or cooling properties of garment; and the like. The fitting property may also be a body parameter of the wearer, such as: age; gender; height; weight; and the like. The relevant fitting properties may be provided manually by the customer (e.g., via user interface 128 of customer computer 120), such as during an initialization stage to establish a user profile in application 123, or may be determined to be subsequently used for determined by application, such as based on historical data such as previous garment orders linked to the customer or wearer or similar garments ordered by other customer or for other wearers, using suitable machine learning techniques.

In procedure 194, a fit compatibility of the selected garment is determined and indicated, based on the fit deviation measurements and the relevant garment fitting properties. Referring to FIGS. 1 and 2, garment fit processing module 113 of facilitation server 110 determines a fit compatibility of selected shirt 142, in accordance with the determined fir deviation measurements and the relevant shirt fitting properties for the intended wearer. For example, garment fit processing module 113 may determine that selected shirt 142 has an “82% level of compatibility” for the wearer, using reference shirt 146 as a baseline, and accounting for relevant fitting properties (e.g., type of shirt, shirt material, height and weight of wearer, and the like). Garment fit processing module 113 may apply a differential weighting to the various fit deviation measurements and fitting properties to establish the fit compatibility. In particular, certain deviation measurements may be assigned a higher importance than others (e.g., based on customer input or an automated determination), such as for example collar deviations being assigned greater importance (higher weighting) than deviations at the sleeve or cuff region of a given shirt. Similarly, certain fitting properties may be assigned a higher importance than others (e.g., based on customer input or an automated determination). The determined fit compatibility is notified to the customer through garment fit application 123, such as in the form of a detailed report with all the relevant information. For example, the customer may receive a detailed breakdown of the degree of fit at various portions of the garment (e.g., collar, sleeve, hem, cuff, pocket, and the like) along with relevant deviation measurements at each region, along with an overall (optionally weighted) fit degree value. The customer may consider the provided fit compatibility information, and may also employ human intelligence factors such as intuition or personal experience, in formulating a decision for the possible purchase of the selected garment.

In an optional procedure 226, the 2D selected garment image is converted into a corresponding 3D selected garment image for display, by generating a 3D projection of the 2D selected garment onto a generic 3D body model. Referring to FIGS. 1 and 2, garment fit processing module 113 of facilitation server 110 generates a 3D image of selected shirt 142, by applying a 3D projection of shirt 142 as reflected in selected shirt image 142, onto a generic 3D model of a body. The 3D model image is presented to the customer (e.g., on display 126), which the customer can manipulate to select different perspective views of the selected shirt, such as a front view or side view, which can be compared and contrasted with corresponding views of reference shirt 146. The 3D views of selected shirt 142 may facilitate the customer decision regarding the possible purchase of selected shirt 142.

It is noted that the disclosed method is adapted for garments for which a 2D image is capable of conveying the garment dimensions, such as when laid out flat on a surface, but may also be applied to other types of products. For example, the disclosed method may be applied to products characterized by inherent symmetry, such as mechanical screws. Other examples of applicable products may include: eyeglasses; jewelry; watches; pens; ties; earpieces; mouthguards; gloves; helmets; belts; orthopedic gear; tennis racquets; scarfs; handbags; backpacks; vests; wearable sporting gear; and the like.

While certain embodiments of the disclosed subject matter have been described, so as to enable one of skill in the art to practice the present invention, the preceding description is intended to be exemplary only. It should not be used to limit the scope of the disclosed subject matter, which should be determined by reference to the following claims.

1. A method for facilitating personalized garment fit evaluations over a computer network, irrespective of non-uniform garment sizing options, the method comprising the procedures of:
receiving at least one 2D image of at least one selected garment offered for purchase, the selected garment image comprising a view of the selected garment flattened against a surface, and a measurement reference scale in relation to the selected garment, enabling measurement along any two points of the 2D image;
receiving at least one 2D image of a reference garment having a preferred fit for a customer and of a same garment type as the selected garment, the reference garment image comprising a view of the reference garment flattened against a surface and a measurement reference scale in relation to the reference garment, enabling measurement along any two points of the 2D image;
transforming, if necessary, at least one of the selected garment image and the reference garment image, into a proportional image in which distances between points are presented along a common scale; and comparing the selected garment image with the reference garment image, and determining and providing an indication of at least one fit deviation measurement of the selected garment relative to the reference garment.

2. The method of claim 1, further comprising the procedure of determining and providing an indication of a fit compatibility of the selected garment, based on the fit deviation measurement and based on at least one garment fitting property.

3. (canceled)

4. (canceled)

5. The method of claim 1, wherein the 2D selected garment image is converted into a corresponding 3D selected garment image for display, by generating a 3D projection of the 2D garment onto a generic 3D body model.

6. The method of claim 1, further comprising the procedures of: displaying a visual representation of the selected garment image and the reference garment image; and providing an indication of at least one measurement between two selected points on at least one of: the reference garment image; and the selected garment image.

7. The method of claim 2, wherein the fit compatibility is determined in accordance with differential weightings assigned to at least one of: a plurality of fit deviation measurements; and a plurality of garment fitting properties.

8. The method of claim 1, wherein at least one of the 2D selected garment image and the 2D reference garment image comprises: a first image of a principal view of the respective garment, and a second image of a supplemental view of the respective garment.

9. The method of claim 1, wherein the fit deviation measurement is expressed as an absolute value or a relative value with respect to at least one body portion of the selected garment.

10. The method of claim 1, wherein the fit deviation measurement is selected from the group consisting of: a linear measurement; a non-linear measurement; and a planar measurement.

11. The method of claim 1, wherein the fit deviation measurement is provided by measuring the distance between two selected points on at least one of: the reference garment image; and the selected garment image.

12. The method of claim 1, wherein the selected garment image comprises a shoe insert image, and wherein the reference garment image comprises at least one of: an image of a reference shoe insert; and a drawing of a foot contour.

13. A system for facilitating personalized garment fit evaluations over a computer network, irrespective of non-uniform garment sizing options, the system comprising:
a garment fit processing module operating on a server computing device coupled to a computer network, the garment fit processing module configured to:
receive at least one 2D image of at least one selected garment offered for purchase, the selected garment image comprising a view of the selected garment flattened against a surface, and a measurement reference scale in relation to the selected garment, enabling measurement along any two points of the 2D image,
receive at least one 2D image of a reference garment having a preferred fit for a customer and of a same garment type as the selected garment, the reference garment image comprising a view of the reference garment flattened against a surface and a measurement reference scale in relation to the reference garment, enabling measurement along any two points of the 2D image;
transform, if necessary, at least one of the selected garment image and the reference garment image, into a proportional image in which distances between points are presented along a common scale;
compare the selected garment image with the reference garment image and determine and provide an indication of at least one fit deviation measurement of the selected garment relative to the reference garment, and
a garment fit application executed on a client computing device coupled to a computer network, the garment fit application configured to receive and display the provided indication.

14. The system of claim 13, wherein the garment fit processing module is further configured to determine and provide an indication of a fit compatibility of the selected garment, based on the fit deviation measurement and based on at least one garment fitting property.

15. (canceled)

16. The system of claim 13, wherein the garment fit processing module is further configured to convert the 2D selected garment image into a corresponding 3D selected garment image for display, by generating a 3D projection of the 2D garment onto a generic 3D body model.

17. The system of claim 13, wherein the garment fit processing module is further configured to display a visual representation of the selected garment image and the reference garment image, and to provide an indication of at least one measurement between two selected points on at least one of: the reference garment image; and the selected garment image.

18. The system of claim 14, wherein the fit compatibility is determined in accordance with differential weightings assigned to at least one of: a plurality of fit deviation measurements; and a plurality of garment fitting properties.

19. The system of claim 13, wherein at least one of the 2D selected garment image and the 2D reference garment image comprises a first image of a principal view of the respective garment, and a second image of a supplemental view of the respective garment.

20. The system of claim 13, wherein the fit deviation measurement is expressed as an absolute value or a relative value with respect to at least one body portion of the selected garment.

21. The system of claim 13, wherein the fit deviation measurement is selected from the group consisting of: a linear measurement; a non-linear measurement; and a planar measurement.

22. The system of claim 13, wherein the fit deviation measurement is provided by measuring the distance between two selected points on at least one of: the reference garment image; and the selected garment image.

23. The system of claim 13, wherein the selected garment image comprises a shoe insert image, and wherein the reference garment image comprises at least one of: an image of a reference shoe insert; and a drawing of a foot contour.
